(19) United States
(12) Patent Application Publication
(10) Pub. No.: US 2017/0142807 A1
(43) Pub. Date: May 18, 2017

(54) DIMMER CONTROL AND LIGHTING SYSTEM INCLUDING THE SAME

(71) Applicant: EATON CORPORATION, CLEVELAND, OH (US)

(72) Inventors: OSCAR LEWIS NEUNDORFER, SENOIA, GA (US); DAVID ALLEN WESTBROOK, HAMPTON, GA (US)

(73) Assignee: EATON CORPORATION, CLEVELAND, OH (US)

(21) Appl. No.: 14/938,982

(22) Filed: Nov. 12, 2015

(51) Int. Cl. H05B 37/02

(52) U.S. Cl. CPC H05B 37/0209

(57) ABSTRACT

A dimmer control includes a plurality of control element units each being operable to select a level between fully on and fully off and a plurality of control units, each control unit corresponding to one of the control element units and being structured to output a control signal based on the level selected by the corresponding control element unit. Each control unit is structured to electrically couple with a control input of a light fixture and the light fixture is structured to control a corresponding controllable characteristic of itself based on the control signal output by the control unit.

### BACKGROUND

Field

The disclosed concept relates generally to dimmer controls, and more particularly, to dimmer controls for use with light fixtures that have multiple control inputs. The disclosed concept also relates to lighting systems including dimmer controls.

Background Information

Dimmer controls are commonly used to control the intensity of a light fixture. A dimmer control is typically mounted to an electrical box disposed in a wall or other suitable structure, and is electrically connected between a power source and the light fixture. The dimmer control generally includes a faceplate coupled to the electrical box, and a user interface, such as a linear slider. The dimmer control may also include a button or toggle for switching the light fixture ON and OFF. The linear slider is adjustable (i.e., movable) to correspondingly control the dimming of the light fixture.

Dimmer controls have been commonly used to control the intensity of a light fixture. However, while light fixtures have become more advanced, advancements in dimmer controls have not been fully explored.

There is room for improvement in dimmer controls.

There is also room for improvement in lighting systems including dimmer controls.

### SUMMARY

These needs and others are met by embodiments of the disclosed concept, which are directed to a dimmer control for use with a light fixture having a plurality of controllable characteristics. The dimmer control includes a plurality of control units, each corresponding to one of the controllable characteristics of the light fixture.

In accordance with aspects of the disclosed concept, a dimmer control for use with a light fixture having a plurality of control inputs each corresponding to a controllable characteristic of the light fixture comprises: a plurality of control element units each being operable to select a level between fully on and fully off; and a plurality of control units, each control unit corresponding to one of the control element units and being structured to output a control signal based on the level selected by the corresponding control element unit, wherein each control unit is structured to electrically couple with one of the control inputs of the light fixture and the light fixture is structured to control the corresponding controllable characteristic based on the control signal output by the control unit.

In accordance with other aspects of the disclosed concept, a lighting system comprises: a light fixture having a plurality of controllable characteristics, the light fixture including: a light element; and a driver unit structured to control the plurality of controllable characteristics of the light fixture and having a plurality of light control units each corresponding to one of the controllable characteristics; and a dimmer control including: a plurality of control element units each being operable to select a level between fully on and fully off; and a plurality of control units, each control unit corresponding to one of the control element units and being structured to output a control signal based on the level selected by the corresponding control element unit, wherein each control unit is electrically coupled with one of the light control units of the light fixture and the light control unit is structured to control the corresponding controllable characteristic based on the control signal output by the control unit.

### BRIEF DESCRIPTION OF THE DRAWINGS

A full understanding of the disclosed concept can be gained from the following description of the preferred embodiments when read in conjunction with the accompanying drawings in which:

FIG. 1 is a schematic diagram of lighting system in accordance with an example embodiment of the disclosed concept; and

FIG. 2 is a front view of a dimmer control included in the lighting system of FIG. 1.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

As employed herein, the term “number” shall mean one or an integer greater than one (i.e., a plurality).

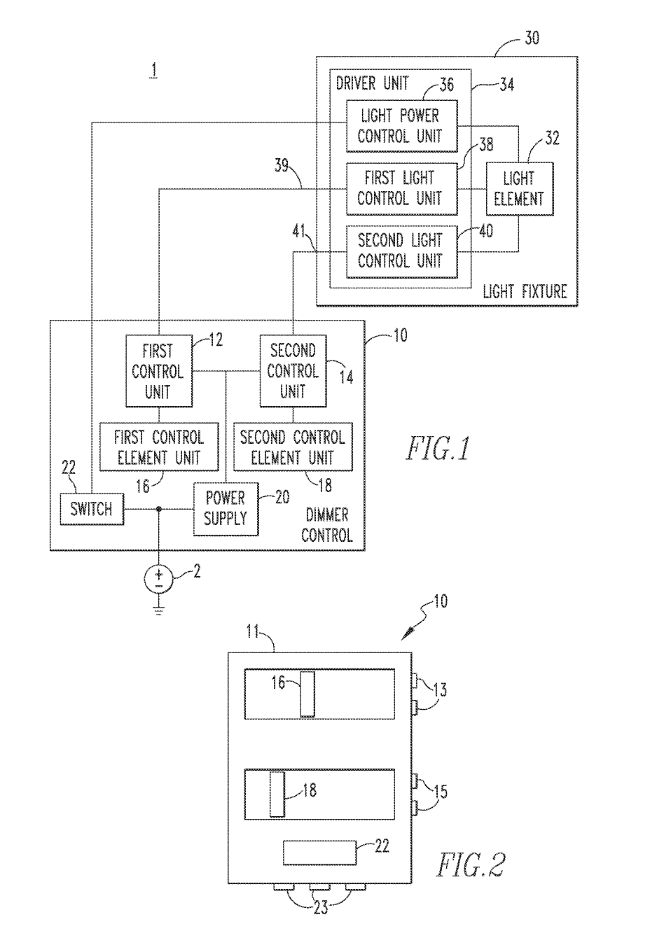

FIG. 1 is a schematic diagram of a lighting system 1 in accordance with an example embodiment of the disclosed concept. The lighting system 1 includes a dimmer control 10 and a light fixture 30. The dimmer control 10 is electrically connected between the light fixture 30 and a power source 2.

The dimmer control 10 includes a first control unit 12 and a second control unit 14. The dimmer control 10 further includes a control element unit 16 that corresponds to the first control unit 12 and a second control element unit 18 that corresponds to the second control unit 14. The first and second control element units 16,18 are physical devices, or a combination of physical devices and electrical elements, that may be manipulated by a user to select a level between fully OFF and fully ON. In some example embodiments of the disclosed concept, the first and second control element units 16,18 are linear sliders that are capable of sliding between a fully OFF position, a fully ON position, and any position in between the two in order to select a level between fully ON and fully OFF. The outputs of the first and second control units 12,14 are based on the levels selected by the first and second control element units 16,18. It will be appreciated by those having ordinary skill in the art that any suitable type of control element unit capable of being used to select a level between fully ON and fully OFF may be employed without departing from the scope of the disclosed concept. In some example embodiments of the disclosed concept, the control element units 16,18 are actuators such as, without limitation, a linear slider or a rotatable knob. In some other example embodiments of the disclosed concept, the control element units 16,18 include push buttons and underlying electronic circuitry to select a level between fully ON and fully OFF, for example, by pushing one push button to raise the selected level and pushing another push button to lower the selected level.

The dimmer control 10 also includes a power supply 20. The power supply 20 is structured to convert power from the power source 2 for use by the dimmer control 10. For example and without limitation, the first and second control units 12,14 may use low voltage DC power while the power source 2 provides a higher voltage AC power. The power supply 20 will perform an AC-DC conversion on the power and scale it to the voltage level used by the first and second control units 12,14.

The dimmer control 10 may further include a switch 22. The switch 22 is electrically connected between the power source 2 and the light fixture 30. Closing the switch 22 allows power to flow to the light fixture 30 to turn ON the light fixture 30. Opening the switch 22 prevents power from flowing to the light fixture 30 to turn OFF the light fixture 30. In some example embodiments of the disclosed concept, the switch 22 is a device that is physically actuatable by a user (e.g., without limitation, a physical switch or button) to open or close the switch 22. In some other example embodiments of the disclosed concept, the switch 22 is provided as electronic components such as triacs or transistors that are electronically controlled through a physical interface such as a push button switch. In yet other example embodiments of the disclosed concept, the switch 22 is provided as a relay that may be electronically controlled based on the output of the first or second control units 12,14. In yet other example embodiments of the disclosed concept, the switch 22 is omitted and the light fixture 30 includes circuitry to turn itself ON or OFF based on outputs of the first or second control units 12,14.

The light fixture 30 includes a light element 32 (e.g., without limitation, one or more light emitting diodes (LEDs), one or more fluorescent lights, one or more incandescent lights, or any other suitable type of light element). The light fixture 30 also includes a driver unit 34. The driver unit 34 is structured to control the light element 32 and a plurality of characteristics of the light fixture 30. That is, the driver unit 34 is structured to control the ON/OFF state of the light element 32 and at least two other controllable characteristics of the light fixture 30. In some example embodiments of the disclosed concept, the at least two other controllable characteristics include the intensity of the light element 32 (e.g., without limitation, a dimming function) and the color of the light element 32 (e.g., without limitation, a color changing function). The light fixture 30 includes a plurality of control inputs 39,41, that each correspond to one of the controllable characteristics of the light fixture 30. The light fixture 30 controls the controllable characteristics based on control signals received through the control inputs 39,41. It will be appreciated by those having ordinary skill in the art that the light fixture 30 may have other controllable characteristics such as, without limitation, softness of the light element 32, motion control for changing the position of the light fixture 30 to facilitate aiming through pan and tilt functions, iris control to narrow or broaden the light beam provided by the light element 32, and focus control to sharpen or soften the light beam provided by the light element 32.

In more detail, the first and second control units 12,14 are electrically coupled to the control inputs 39,41 respectively. Control signals received at the control inputs 39,41 are provided to a first light control unit 38 and a second light control unit 40 included in the driver unit 34. The first light control unit 38 is structured to control a first characteristic of the light fixture 30 (e.g., without limitation, the intensity of the light element 32) based on the control signal output from the first control unit 12. The second light control unit 40 is structured to control a second characteristic of the light fixture 30 (e.g., without limitation, the color of the light element 32) based on the output of the second control unit 14.

The driver unit 34 also includes a light power control unit 36. The light power control unit 36 is electrically coupled to the output of the switch 22 and is structured to receive power from the power source 2 via the switch 22. In some example embodiments of the disclosed concept, the light power control unit 36 is structured to convert power received from the power source 2 for use by the light element 32 (e.g., without limitation, AC-DC conversion, level shifting, etc.).

In some example embodiments of the disclosed concept, the first and second control units 12,14 produce control signals in accordance with a 0-10V protocol and the first and second light control units 38,40 are accordingly structured to receive the control signals according to the 0-10V protocol. For example, the outputs of the first and second control units 12,14 will vary between 0 and 10V based on the levels selected by the first and second control element units 16,18. It will be appreciated by those having ordinary skill in the art that the first and second control units 12,14 may communicate with the first and second light control units 38,40 using any suitable protocol without departing from the scope of the disclosed concept. For example and without limitation, a 1-10V protocol, a digital addressable lighting interface (DALI) protocol, a digital multiplex (DMX or DMX512) protocol, a digital serial interface (DSI) protocol, phase cut or any other suitable communication scheme may be employed for communication between the first and second control units 12,14 and the first and second lighting control units 38,40 without departing from the scope of the disclosed concept.

In the example embodiment shown in FIG. 1, the dimmer control 10 includes first and second control units 12,14 and the light fixture 30 includes corresponding first and second light control units 38,40. However, it will be appreciated by those having ordinary skill in the art that the dimmer control 10 may include more than two control units and the light fixture 30 may include more than two corresponding light control units without departing from the scope of the disclosed concept. For example and without limitation, a lighting system may include a dimmer control with four control units, or any other number of control units, and a light fixture with four corresponding light control units, or any other number of corresponding light control units, to control four characteristics, or any other number of characteristics, of its light element.

FIG. 2 is a front view of the dimmer control 10 of FIG. 1. The dimmer control 10 includes a housing 11 that substantially forms an exterior shape of the dimmer control 10 and houses its components. As shown in FIG. 2, the dimmer control 10 includes the first control element unit 16, the second control element unit 18 and the switch 22. In this example embodiment of the disclosed concept, the first and second control element units 16,18 are linear sliders and the switch 22 is a button. However, it will be appreciated by those having ordinary skill in the art that other suitable devices may be employed as the first and second control element units 16,18 and the switch 22 without departing from the scope of the disclosed concept.

The dimmer control 10 also includes first control terminals 13 and second control terminals 15. The first control terminals 13 are electrically connected to the first control unit 12 (shown in FIG. 1). Conductors may be employed to electrically connect first control unit 12 to the first light control unit 38 of the light fixture 30 via the first control terminals 13. Similarly, the second control terminals 15 are electrically connected to the second control unit 14 (shown in FIG. 1) and conductors may be employed to electrically connect the second control unit 14 to the second light control unit 40 of the light fixture 30 via the second control terminals 15.

The dimmer control 10 further includes power terminals 23. Conductors may be employed to electrically connect the dimmer control 10 to the power source 2 and the light power control unit 36 of the light fixture 30 via the power terminals 23.

By including a plurality of control units 12,14 and associated control element units 16,18 in the dimmer control 10, multiple controllable characteristics of the light fixture 30 may be controlled from the dimmer control 10.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A dimmer control for use with a light fixture having a plurality of control inputs each corresponding to a controllable characteristic of the light fixture, the dimmer control comprising:
a plurality of control element units each being operable to select a level between fully on and fully off; and
a plurality of control units, each control unit corresponding to one of the control element units and being structured to output a control signal based on the level selected by the corresponding control element unit,
wherein each control unit is structured to electrically couple with one of the control inputs of the light fixture and the light fixture is structured to control the corresponding controllable characteristic based on the control signal output by the control unit.

2. The dimmer control of claim 1, further comprising:
a switch electrically connected between a power source and the light fixture,
wherein the switch is structured to open to prevent power from flowing from the power source to the light fixture and to close to allow power to flow from the power source to the light fixture.

3. The dimmer control of claim 2, wherein the switch is an electrically controlled relay controlled by an output of one of the plurality of control units.

4. The dimmer control of claim 1, further comprising:
a power supply structured to electrically connect to a power source and convert power received from the power source for use by the plurality of control units.

5. The dimmer control of claim 1, wherein at least one of the plurality of control element units is an actuator being actuatable to any of a plurality of positions between fully on and fully off to select the level between fully on and fully off.

6. The dimmer control of claim 5, wherein the actuator is a linear slider.

7. The dimmer control of claim 1, wherein at least one of the plurality of control units is structured to output the control signal in accordance with a 0-10V protocol.

8. The dimmer control of claim 1, wherein the plurality of control element units is two control element units and the plurality of control units is two control units.

9. The dimmer control of claim 7, wherein the control inputs of the light fixture include a first control input corresponding to a controllable intensity characteristic of the light fixture and a second control input corresponding to a controllable color characteristic of the light fixture.

10. The dimmer control of claim 1, further comprising:
a housing structured to house the plurality of control element units and the plurality of control units.

11. The dimmer control of claim 10, wherein the housing includes power terminals and control terminals, and wherein the dimmer control is structured to electrically couple with a power source via the power terminals and to electrically couple with the control inputs of the light fixture via the control terminals.

12. A lighting system comprising:
a light fixture having a plurality of controllable characteristics, the light fixture including:
a light element; and
a driver unit structured to control the plurality of controllable characteristics of the light fixture and having a plurality of light control units each corresponding to one of the controllable characteristics; and
a dimmer control including:
a plurality of control element units each being operable to select a level between fully on and fully off; and
a plurality of control units, each control unit corresponding to one of the control element units and being structured to output a control signal based on the level selected by the corresponding control element unit,
wherein each control unit is electrically coupled with one of the light control units of the light fixture and the light control unit is structured to control the corresponding controllable characteristic based on the control signal output by the control unit.

13. The lighting system of claim 12, wherein the dimmer control further comprises:
a switch electrically connected between a power source and the light fixture,
wherein the switch is structured to open to prevent power from flowing from the power source to the light fixture and to close to allow power to flow from the power source to the light fixture.

14. The lighting system of claim 13, wherein the switch is an electrically controlled relay controlled by an output of one of the plurality of control units.

15. The lighting system of claim 12, wherein the dimmer control further comprises:
a power supply structured to electrically connect to a power source and convert power received from the power source for use by the plurality of control units.

16. The lighting system of claim 12, wherein at least one of the plurality of control element units is an actuator being actuatable to any of a plurality of positions between fully on and fully off to select the level between fully on and fully off.

17. The lighting system of claim 16, wherein the actuator is a linear slider.

18. The lighting system of claim 12, wherein at least one of the plurality of control units is structured to output the control signal in accordance with a 0-10V protocol and at least one of the plurality of the light control units is structured to receive control signals in accordance with the 0-10V protocol.

19. The lighting system of claim 12, wherein the plurality of control element units is two control element units, the plurality of control units is two control units and the plurality of light control units is two light control units, and wherein the controllable characteristics of the light fixture include a controllable intensity characteristic and a controllable color characteristic.

20. The lighting system of claim 12, wherein the dimmer control further comprises:
a housing structured to house the plurality of control element units and the plurality of control units.

21. The lighting system of claim 20, wherein the housing includes power terminals and control terminals, and wherein the dimmer control is electrically coupled with a power source via the power terminals and electrically coupled with the light control units of the light fixture via the control terminals.

22. The lighting system of claim 12, wherein the light element includes at least one of a light emitting diode, a fluorescent light and an incandescent light.
